(19) United States
(12) Patent Application Publication
(10) Pub. No.: US 2006/0180404 A1
(43) Pub. Date: Aug. 17, 2006

(54) Elevator installation with hoistway door and door-closing device

(75) Inventor: Jules Christen, Altdorf (CH)

Correspondence Address: BUTZEL LONG;DOCKETING DEPARTMENT, 100 BLOOMFIELD HILLS PARKWAY, SUITE 200, BLOOMFIELD HILLS, MI, 48304, US

(73) Assignee: Inventio AG

(21) Appl. No.: 11/311,089

(22) Filed: Dec. 19, 2005

(30) Foreign Application Priority Data
Dec. 20, 2004 (EP) 04106753.9

(51) Int. Cl. B66B 13/02

(52) U.S. Cl. 187/315

(57) ABSTRACT

An elevator installation has an elevator hoistway with at least one hoistway door. The hoistway door has at least one horizontally movable hoistway-door panel and a door-closing device with an energy store to cause a closing movement of the hoistway-door panel, the energy store being arranged in a space between the opened hoistway-door panel and the hoistway wall on the hoistway-door side.

### BACKGROUND OF THE INVENTION

The present invention relates to an elevator installation with a hoistway door with at least one horizontally movable hoistway-door panel and a door-closing device.

A door-closing device on a hoistway door of an elevator serves the purpose of closing the hoistway-door panel or panels, or keeping it or them closed, at all times when the elevator car is not positioned immediately adjacent to this hoistway door and causing it to be opened or held open.

Japanese patent document JP 2000211859 discloses a hoistway door with horizontally movable hoistway-door panels and with a door-closing device. The latter contains an energy store executed as a tension spring which can provide the necessary force and energy for a closing operation. The tension spring is so arranged that its longitudinal axis is aligned vertically, its lower end being permanently fastened to the door sill and its upper end being connected to a flexible pulling means. With the aid of a diverter pulley, this pulling means transforms the vertically acting spring force into a horizontal force which acts on one of two hoistway-door panels and attempts to move it in its direction of closure. The tension spring is arranged in the direction of the hoistway-door width outside the area occupied by the maximally opened hoistway-door panel.

The door-closing device disclosed in JP 2000211859 has the disadvantage that with restricted hoistway width the maximum attainable width of the door opening is reduced through the energy store (tension spring) being built in between the outer edge of the one hoistway-door panel and the side wall of the hoistway, thereby preventing the outer edge of the hoistway-door panel from being able to be moved as far as the side wall of the hoistway when the hoistway door is opened.

### SUMMARY OF THE INVENTION

An objective of the present invention is to provide an elevator installation with a hoistway door and a door-closing device which does not have the disadvantage of the aforesaid state of the art, i.e. in which, with restricted width of the elevator hoistway, the width of the door opening of the hoistway doors attains a maximum.

According to the present invention, the objective is fulfilled in that in an elevator installation which has a hoistway door with at least one hoistway-door panel and a door-closing device with at least one energy store, the energy store is arranged in a space between the opened hoistway-door panel and the hoistway wall on the same side as the hoistway door.

By means of the present invention, the advantage is obtained that with the energy store that is present in the form of, for example, a spring or closing weight, no space is taken up through its being built in between the outer edge of an opened hoistway-door panel and the side wall of the hoistway, as a result of which for a given hoistway width a maximal width of door opening is attainable. The principle according to the present invention can be applied to side- or center-closing hoistway doors as well as to simple and telescopic doors.

Expedient and inexpensive embodiments of the present invention are provided with energy stores in one of the following embodiments:
Closing weight, advantageously guided in a stationary guide tube;
Tension spring in the form of a helical spring;
Tension spring in the form of a spiral spring acting on a rope drum; and
Combination of a closing weight and a tension spring, a closing weight being arranged, for example, inside a helical spring and both acting via a common pulling means on a hoistway-door panel.

It is expedient for at least one energy store to be connected by connecting means to the hoistway-door panel in such manner as to exert a force acting in the direction of closure of the hoistway-door panel at all times.

A space-saving and inexpensive embodiment of the present invention consists of the energy store being connected to the hoistway-door panel by means of at least one flexible connecting means, for example a rope or belt of steel wires or synthetic-fiber strands, the flexible connecting means being guided over at least one diverter pulley so as to direct the effect of the force of the energy store onto the hoistway-door panel in such manner that the latter experiences a closing force.

A maximal width of the door opening with restrictive width of the elevator hoistway is attained through there being present between the vertical outer edge of the opened hoistway-door panel on the hoistway-door side of the hoistway wall and the side wall of the hoistway adjacent to this outer edge a gap of less than 25 mm.

According to a further embodiment of the present invention, several energy stores are employed to close the hoistway door, several energy stores acting together on one single hoistway-door panel, or several hoistway-door panels being driven by at least one energy store each. By this means, the dimensions of the energy store and therefore the gap required between the opened hoistway-door panel and the hoistway wall on the hoistway-door side can be reduced to a minimum.

According to a preferred embodiment of the present invention, the upper area of the hoistway-door panel is guided on a horizontal guide fastened to a hoistway-door head-jamb and its door-sill area on a door-sill section parallel to the said horizontal guide. To create sufficient space for building-in the energy store between the opened hoistway-door panel and the hoistway wall on the side of the hoistway-door, the hoistway-door head-jamb with the horizontal guide and the door-sill section are fastened at a correspondingly adapted distance from the hoistway wall on the hoistway-door side.

A particularly simple and inexpensive embodiment of the present invention consists of the hoistway door having vertical door jambs which together with the hoistway-door head-jamb form part of a hoistway-door frame, the vertical jambs of the hoistway-door frame being fastened by adjustable fastening means to the hoistway-wall on the hoistway-door side in such manner that the said gap between the hoistway-door head-jamb and the door-sill section can be adjusted from the hoistway wall on the hoistway-door side.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is an elevation view of a hoistway door according to the present invention with two hoistway-door panels and two door-closing devices viewed from inside the elevator hoistway;

FIG. 2 is a horizontal section taken along the line II-II in FIG. 1 through the hoistway door in the area of the head-jamb;

FIG. 3 is a vertical section taken along the line III-III in FIG. 1 through the hoistway door in the area of an energy store (closing weight);

FIGS. 4A-4F show diagrammatically variants of hoistway doors with the arrangement of a closing weight according to the present invention;

FIGS. 5A-5E show diagrammatically different embodiments of the energy store.

### DESCRIPTION OF THE PREFERRED EMBODIMENT

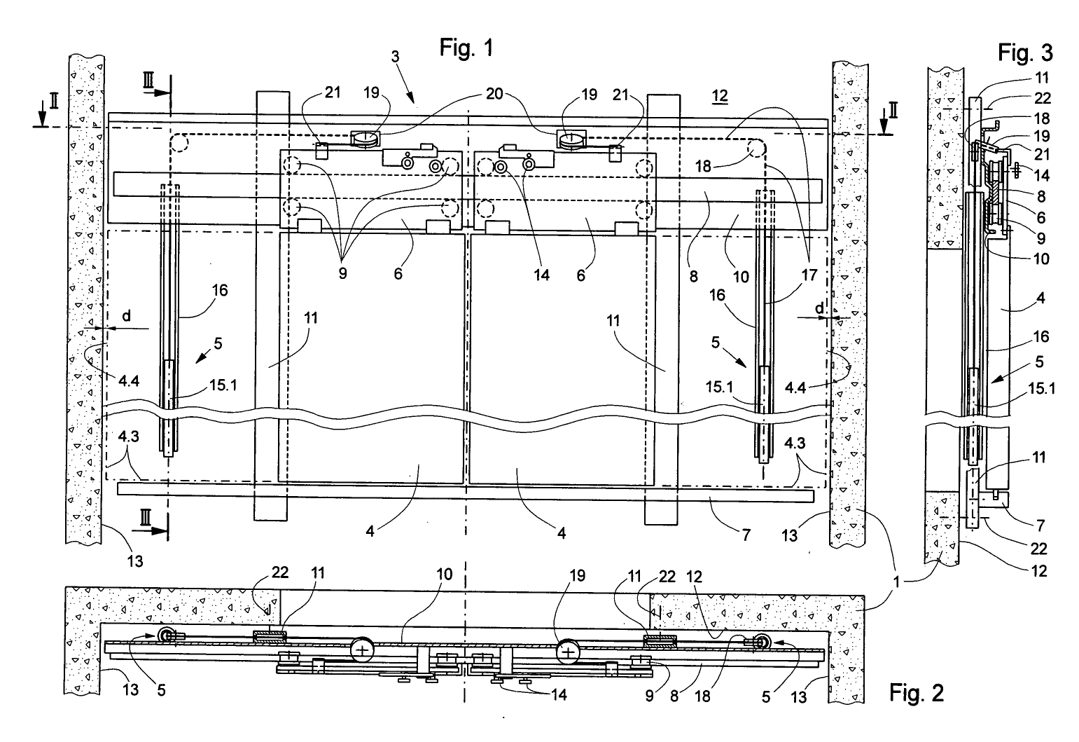

FIGS. 1, 2, and 3 show diagrammatically a hoistway door 3 according to the present invention which is built into an elevator hoistway 1 and has two center-opening hoistway-door panels 4, there being assigned to each hoistway-door panel one of two door-closing devices 5. In their upper area the hoistway-door panels 4 are each attached to a different door-hanger 6 and in their lower area are guided in a groove of a door-sill section 7. The door-hanger 6 is guided by means of door-hanger rollers 9 on a horizontal guide 8, the horizontal guide 8 being rigidly fastened to a hoistway-door head-jamb 10. The hoistway-door head-jamb 10 and door-sill section 7 together with two vertical door jambs 11 form a hoistway-door frame, the two door jambs 11 being fastened to a hoistway wall 12 on the hoistway-door side by means of fastening means 22.

For the purpose of opening and closing the hoistway door 3, the hoistway-door panels 4 can be moved horizontally. In normal operation of the elevator, the hoistway-door panels 4 are opened and closed by a door coupling, which is connected to the door panels of an elevator-car door (not shown), engaging with coupler rollers 14 connected to the door-hanger 6.

To ensure that the hoistway-door panels 4 are always closed when the elevator car is not positioned on the assigned floor, the hoistway door 3 is equipped with the door-closing devices 5. Each of these door-closing devices contains an energy store in the form of a closing weight 15.1. The energy stores (closing weights 15.1) are each connected by means of flexible pulling means 17, i.e. each by a different flexible rope or belt, to the door-hanger 6 of the hoistway-door panel 4 so as to exert on the latter a closing force at all times. With the aid of a first diverter pulley 18 mounted on the rear side of the hoistway-door head-jamb 10, the flexible pulling means 17 are diverted from their vertical direction into a horizontal direction in the direction of movement of the hoistway-door panel, and with the aid of a second diverter pulley 19 their direction of motion is again diverted through 180° so that the weight force of the closing weights 15.1 is transformed into a door-closing force acting in the direction of the closing movement of the hoistway-door panel 4. The second diverter pulleys 19 are placed in openings 20 present in the hoistway-door head-jamb and supported on the hoistway-door head-jamb 10. This arrangement makes it possible to divert the flexible pulling means 17, that start from the closing weights 15.1 and run between the hoistway-door panels 4 and rear side of the hoistway-door head-jamb 10 at one end and the hoistway-door side hoistway wall 12 at the other end, onto the front side of the hoistway-door head-jamb and to fastening points 21 present on the door-hanger 6.

Different than the door-closing devices known from the state-of-the-art, in the solution according to the present invention the energy stores, i.e. in the case illustrated the closing weights 15.1, are not built in between an outer edge 4.4 of the hoistway-door panel 4 and the respective adjacent side walls 13 of the hoistway but placed between the opened hoistway-door panels 4 and the hoistway wall 12 on the hoistway-door side. By this means it is made possible for the hoistway-door panels to be opened as far as an open position 4.3 indicated in FIG. 1 by projected lines in which between the vertical outer edges 4.4 of the hoistway-door panels 4 and the respective adjacent side walls 13 of the hoistway only a minimal gap “d” is required which is typically less than 25 mm.

The closing weights 15.1 are each guided in a respective guide tube 16 which tubes are preferably fastened to the hoistway-door head-jamb 10.

The fastening means 22 with which the two vertical door jambs 11 of the aforesaid hoistway-door frame are fastened to the hoistway wall 12 on the hoistway-door side are executed to be adjustable. This makes it possible to adjust the distance between the door jambs 11 and the hoistway wall 12 to the requirements of the placement of the closing weights 15.1 between the hoistway-door panels 4 and the hoistway wall 12 on the hoistway-door side.

The solution shown, with the energy stores (closing weights 15.1) built in between the opened hoistway-door panels 4 and the hoistway wall 12 on the hoistway-door side, can self-evidently also be used on other variants of hoistway doors.

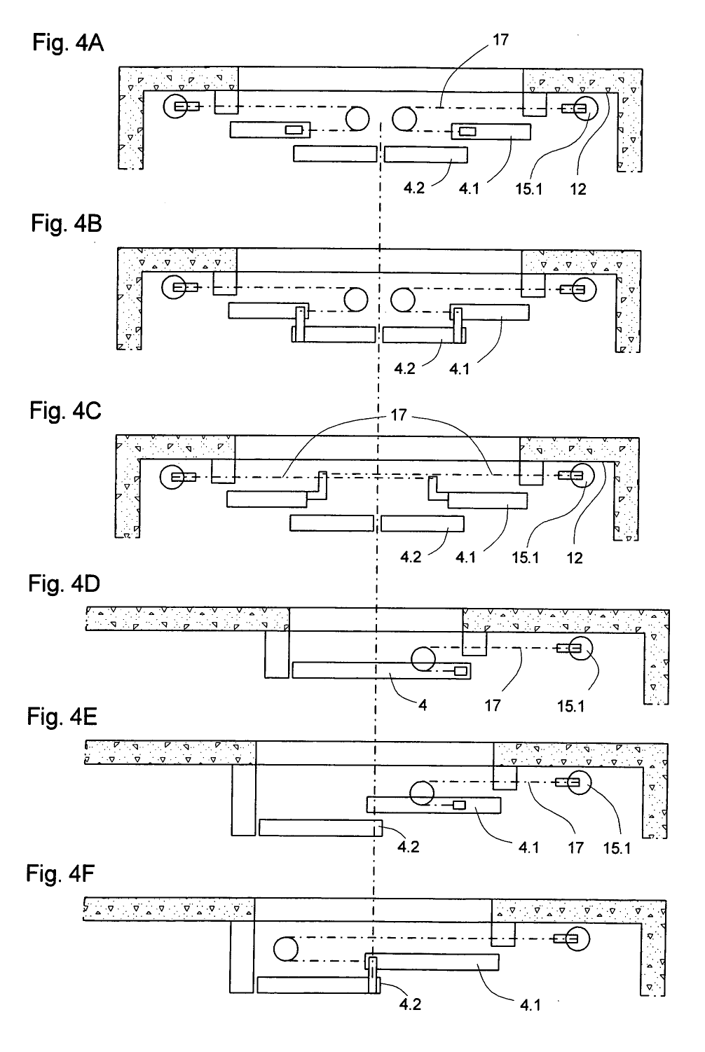

Such exemplary applications are shown diagrammatically in FIGS. 4A-4F.

FIG. 4A shows a center-closing hoistway door with telescopically arranged hoistway-door panels 4.1, 4.2, the closing weights 15.1 acting via the flexible pulling means 17 with a second deflection (180° deflection) on the slow-running hoistway-door panel 4.1 (door-internal synchronization of the movements of the slow- and fast-running hoistway-door panels not shown).

FIG. 4B shows a center-closing hoistway door with the telescopically arranged hoistway-door panels 4.1, 4.2, the closing weights acting on the fast-running hoistway-door panels 4.2.

FIG. 4C shows a center-closing hoistway door with the telescopically arranged hoistway-door panels 4.1, 4.2, the closing weights 15.1 on one side of the door-center acting via the flexible pulling means 17 without a second deflection (180° deflection) on the slow-running hoistway-door panels 4.1 (door-internal synchronization of the movements of the slow- and fast-running hoistway-door panels not shown).

FIG. 4D shows a side-closing hoistway door with the simple hoistway-door panel 4, a closing weight 15.1 acting via the flexible pulling means 17 with a second deflection (180° deflection) on the hoistway-door panel 4.

FIG. 4E shows a side-closing hoistway door with the telescopically arranged hoistway-door panels 4.1, 4.2, the closing weight 15.1 acting via the flexible pulling means 17 with a second deflection (180° deflection) on the slow-running hoistway-door panel 4.1 (door-internal synchronization of the movements of the slow- and fast-running hoistway-door panels not shown).

FIG. 4F shows a side-closing hoistway door with the telescopically arranged hoistway-door panels 4.1, 4.2, the closing weight 15.1 acting via the flexible pulling means 17 with a second deflection (180° deflection) on the fast-running hoistway-door panel 4.2 (door-internal synchronization of the movements of the slow- and fast-running hoistway-door panels not shown).

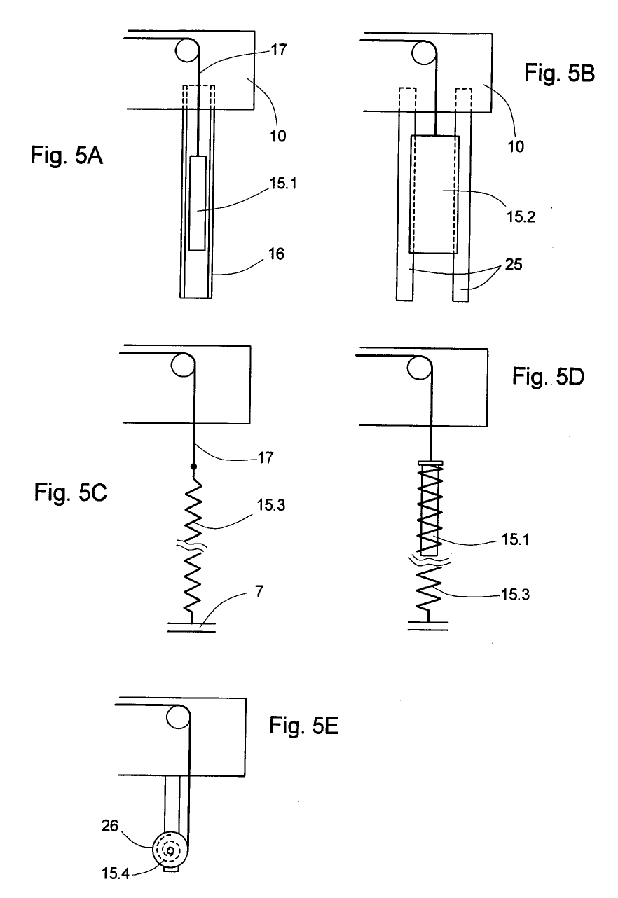

Shown diagrammatically in FIGS. 5A-5E are several embodiments of possible energy stores for exerting a closing force on the hoistway-door panels. On opening of the hoistway door, the closing energy that is temporarily stored in the energy stores is delivered through the door drive normally installed on the elevator car.

FIG. 5A shows the energy store known from the foregoing description having the form of the closing weight 15.1 which acts via the flexible pulling means 17 on the hoistway-door panel in the direction of closure. Shown is the cylindrical closing weight 15.1 which is guided in the guide tube 16 fastened to the hoistway-door head-jamb 10.

FIG. 5B shows an energy store in the form of a slab-shaped closing weight 15.2 that is guided on guide rails 25 which are fastened to the hoistway-door head-jamb 10. By using the slab-shaped closing weight 15.2 the gap required between the opened hoistway-door panel and the hoistway-wall on the hoistway-door side for placement of the closing weight is made as small as possible.

FIG. 5C shows an energy store in the form of a tension spring 15.3 (helical spring) which is connected at one end to the flexible pulling means 17 and at the other end to a part of the hoistway-door frame, preferably to the door-sill section 7.

FIG. 5D shows an energy store which is formed from a combination of the tension spring 15.3 and the cylindrical weight 15.1 guided therein so as to combine their advantages.

By comparison with a closing weight, a spring store has the advantage that at the beginning of the closing movement its closing force is greatest, and can overcome any friction that is present, but during the course of the closing movement becomes less and thereby avoids a forceful impact of the hoistway-door panel on the travel limiter of the closed position. On the other hand, by comparison with the closing weight, the spring store has the disadvantage that, should spring breakage occur, the door-closing device fails.

FIG. 5E shows an energy store in the form of a spiral spring 15.4 acting on a rope sheave 26. The spiral spring 15.4 exerts a torque on the rope sheave 26 which in consequence thereof creates a pulling force in the flexible pulling means 17 fastened to it.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator installation having an elevator hoistway with a hoistway wall on a hoistway-door side, at least one hoistway door with at least one horizontally movable hoistway-door panel adjacent to the hoistway wall on the hoistway-door side, and at least one door-closing device, the door-closing device comprising an energy store for storing energy to cause a closing movement of the hoistway-door panel, said energy store being arranged in a space between the opened hoistway-door panel and the hoistway wall on the hoistway-door side.

2. The elevator installation according to claim 1 wherein said energy store is one of a closing weight, a helical tension spring, and a spiral tension spring.

3. The elevator installation according to claim 1 wherein said energy store is a combination of said closing weight and said tension spring.

4. The elevator installation according to claim 1 wherein said energy store is connected by a connecting means to the at least one hoistway-door panel to exert a force acting in a direction of closure of the at least one hoistway-door panel at all times.

5. The elevator installation according to claim 4 wherein said connecting means comprises a flexible rope or belt which is guided over at least one diverter pulley to direct the force of said energy store onto the at least one hoistway-door panel as a closing force.

6. The elevator installation according to claim 1 wherein a gap of less than 25 mm present between a vertical outer edge of the opened at least one hoistway-door panel on the hoistway-door side of the hoistway wall and a side wall of the hoistway adjacent to the outer edge.

7. The elevator installation according to claim 1 wherein for closing at least two of said energy stores act together on the at least one hoistway-door panel.

8. The elevator installation according to claim 1 wherein for closing at least two hoistway-door panels individual energy stores act on associated ones of the at least two hoistway-door panels.

9. The elevator installation according to claim 1 wherein an upper area of the at least one hoistway-door panel is guided on a horizontal guide that is joined to a hoistway-door head-jamb and is guided at a lower area on a door-sill section that is parallel to said horizontal guide, said hoistway-door head-jamb and said door-sill section being at a predetermined distance from the hoistway wall on the hoistway-door side to provide sufficient space for said energy store between the opened at least one hoistway-door panel and the hoistway wall on the hoistway-door side.

10. The elevator installation according to claim 9 wherein the at least one hoistway door has vertical door jambs which together with said hoistway-door head-jamb form part of a hoistway-door frame, said hoistway-door frame being fastened at said vertical jambs by an adjustable fastening means to the hoistway-door side hoistway-wall for adjusting gaps between the hoistway-door side hoistway wall on one side and said hoistway-door head-jamb with said horizontal guide and said door-sill section on another side.

11. The elevator installation according to claim 1 wherein the hoistway door is one of a side-closing hoistway door and a center-closing hoistway door.

12. The elevator installation according to claim 11 wherein the hoistway-door has at least two telescoping hoistway-door panels.
